(19) United States
(12) Patent Application Publication
(10) Pub. No.: US 2008/0303993 A1
(43) Pub. Date: Dec. 11, 2008

(54) TRANSFLECTIVE PIXEL

(75) Inventors: Chien-Chung Kuo, Taichung County (TW); Chien-Chung Chen, Taichung City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: WINTEK CORPORATION, Taichung (TW)

(21) Appl. No.: 12/131,934

(22) Filed: Jun. 3, 2008

(30) Foreign Application Priority Data
Jun. 5, 2007 (TW) 96120079

(51) Int. Cl. G02F 1/1335; G02F 1/1343

(52) U.S. Cl. 349/114; 349/139

(57) ABSTRACT

A transflective pixel including a gate, a first transflective conductive layer, a gate insulating layer, a channel layer and a conductive layer is provided on a substrate. The gate and the first transflective conductive layer are disposed on the substrate, wherein the first transflective conductive layer is electrically isolated from the gate. The gate insulating layer covers the gate and the first transflective conductive layer. The channel layer is disposed on the gate insulator and located above the gate. The conductive layer including a source, a drain, a data line connected to the source and a second transflective conductive layer connected to the drain is disposed above the gate insulating layer and on part of the channel layer, wherein the second transflective conductive layer is disposed on the gate insulating layer above the first transflective conductive layer.

### CROSS-REFERENCE TO RELATED APPLICATION

This application claims the priority benefit of Taiwan application serial no. 96120079, filed on Jun. 5, 2007. The entirety of the above-mentioned patent application is hereby incorporated by reference herein and made a part of this specification.

### BACKGROUND OF THE INVENTION

1. Field of the Invention

The present invention relates to a pixel. More particularly, the present invention relates to a transflective pixel.

2. Description of Related Art

Along with the rapid development of computer technology and the evolution of the Internet and multimedia technology, the transmission of image information has mostly transformed from analog transmission into digital transmission. Video or image devices are becoming more and more light-weighted and slim-sized to meet the modern life style. The conventional cathode ray tube (CRT) display has been leading the display market for years due to its outstanding performance and lower cost. However, in view of the environment where individuals operate most terminals/display apparatuses at their desks, or in view of environmentalism combined with a general trend of energy-saving, the cathode ray tubes still have many problems in space-utilization and energy consumption, and cannot meet the latest requirements of lighter, slimmer, smaller and energy-saving devices. Therefore, along with the advancement of photoelectric technology and semiconductor manufacturing technology, the recently developed flat panel displays (FPDs), such as liquid crystal display (LCD), organic light emitting diode (OLED) display and plasma display panel (PDP), have become the market-leading display product.

As described above, the liquid crystal displays may be roughly divided into three categories such as reflective LCDs, transmissive LCDs, and transflective LCDs according to the light sources used. For example, a transmissive LCD or a transflective LCD mainly includes a liquid crystal panel and a backlight module (BLM). Since the liquid crystal in the liquid crystal panel is not luminescent by itself, the liquid crystal panel should be lighted up by the light source provided by the backlight module, such that the LCD may achieve its display effect.

FIG. 1 is a schematic diagram of a conventional transflective LCD panel. Referring to FIG. 1, the LCD panel 100 includes a top substrate 110, a bottom substrate 120, a transflective panel 130, a liquid crystal layer 140, a pixel electrode 150 and a common electrode 160. The top substrate 110 is disposed opposite to the bottom substrate 120, the liquid crystal layer 140 is disposed between the top substrate 110 and the bottom substrate 120, and the transflective board 130 is disposed on the bottom substrate 120. Moreover, the pixel electrode 150 is disposed on the transflective panel 130. The pixel electrode 150 and the common electrode 160 disposed on the top substrate 110 are used for modulating the arrangement of the liquid crystal layer 140. In addition, a part of the external lights can be reflected by the transflective board 130, and a part of the lights provided by the backlight source (not shown) may penetrate the transflective board 130. Therefore, the LCD panel 100 may simultaneously have a transmissive display mode and a reflective display mode. However, limited by the transflective board 130, the LCD panel has a low light transmittance and a low light reflectivity. Moreover, to implement a colorful display, a color filter film 170 should be disposed on the top substrate 110. Therefore, the LCD panel 100 has the problems of insufficient brightness and low utilization of backlight source.

FIG. 2 is a schematic diagram of another conventional transflective LCD panel. Referring to FIG. 2, the LCD panel 200 includes a top substrate 210, a bottom substrate 220, a liquid crystal layer 240, a pixel electrode 250 and a common electrode 260. The components of the LCD panel 200 are similar to that of the LCD panel 100, therefore detail description of the components having like reference numerals with that in the LCD panel 100 is omitted. The difference is that in the LCD panel 200, a reflector 230 is further disposed on part of region on the bottom substrate 220 to define a reflective area R, and the part of region on the bottom substrate 220 not covered by the reflector 230 is defined as a transmissive area T. The liquid crystal layer 240 is disposed between the top substrate 210 and the bottom substrate 220. The LCD panel 200 has a reflective display mode and a transmissive display mode. In the reflective display mode, display is implemented only within the reflective area R. On the other hand, in the transmissive display mode, display is implemented only within the transmissive area T of the LCD panel 200. In short, in a single display mode, the aperture ratio of the LCD panel 200 is poor, which will cause a poor utilization of the backlight source and a poor display effect. Moreover, to implement a colorful display, a color filter 270 should be disposed on the top substrate 110, which will cause a poor display effect due to a reduction of the light transmittance.

For improving the backlight utilization and the aperture ratio of the transflective LCD and achieving a good display effect, improvement of the present transflective LCD is necessary.

### SUMMARY OF THE INVENTION

The present invention is directed to a transflective pixel having a structure allowing a colorful display without requiring color filters.

The present invention is directed to a transflective liquid crystal display (LCD) having an enhanced backlight source utilization and aperture ratio.

The present invention provides a transflective pixel disposed on a substrate. The transflective pixel includes a gate, a first transflective conductive layer, a gate insulating layer, a channel layer and a conductive layer. The gate and the first transflective conductive layer are disposed on the substrate, wherein the first transflective conductive layer is electrically isolated from the gate. The gate insulating layer covers the gate and the first transflective conductive layer. The channel layer is disposed on the gate insulating layer and located above the gate. The conductive layer including a source, a drain, a data line connected to the source and a second transflective conductive layer connected to the drain is disposed on the gate insulating layer and on a portion of the channel layer, and forms a n-type thin film transistor. However the connection type of the thin film transistor and the data line is not limited as such. In particular, in another embodiment, the data line may be connected to the drain, and the second transflective conductive layer may be connected to the source to form a p-type thin film transistor. Moreover, the second transflective conductive layer is disposed on the gate insulating layer above the first transflective conductive layer. In still another embodiment, the source of the conductive layer and the channel layer, and the drain of the conductive layer and the channel layer may further include an ohmic contact layer to reduce the resistance between the conductive layer and the channel layer.

The present invention provides another transflective pixel disposed on a substrate. The transflective pixel includes a gate, a first transflective conductive layer, a gate insulating layer, a channel layer, a conductive layer, a passivation layer and a second transflective conductive layer. The gate and the first transflective conductive layer are disposed on the substrate, wherein the first transflective conductive layer is electrically isolated from the gate. The gate insulating layer is disposed on the substrate, and covers the gate. The channel layer is disposed on the gate insulating layer and located above the gate. The conductive layer including a source, a drain and a data line is disposed on part of the channel layer. The passivation layer is disposed on part of the conductive layer. The second transflective conductive layer is disposed on part of the passivation layer, wherein the second transflective conductive layer is electrically connected to the drain, and the second transflective conductive layer is located above the first transflective conductive layer. In an embodiment of the present invention, the gate insulating layer covers the first transflective conductive layer, and the second transflective conductive layer is disposed on the gate insulating layer. Moreover, the passivation layer has a contact window exposing a part of the drain, and the second transflective conductive layer is electrically connected to the drain through the contact window.

In an embodiment of the present invention, the gate insulation layer covers the first transflective conductive layer. The passivation layer covers the gate insulation layer above the first transflective conductive layer. The second transflective conductive layer is disposed on the passivation layer, wherein the passivation layer has a contact window exposing a portion of the drain, and the second transflective conductive layer is electrically connected to the drain through the contact window.

In an embodiment of the present invention, the passivation layer covers the first transflective conductive layer, and the second transflective conductive layer is disposed on the passivation layer, wherein the passivation layer has a contact window exposing a portion of the drain, and the second transflective conductive layer is electrically connected to the drain through the contact window.

In an embodiment of the present invention, the first transflective conductive layer and the second transflective conductive layer form a storage capacitor.

In an embodiment of the present invention, the material of the conductive layer includes silver, silver alloy, aluminum or molybdenum.

The present invention provides still another transflective pixel disposed on a substrate. The transflective pixel includes a gate, a first transflective conductive layer, a gate insulating layer, a channel layer, a conductive layer, a second transflective conductive layer and a passivation layer. The gate and the first transflective conductive layer are disposed on the substrate, wherein the first transflective conductive layer is electrically isolated from the gate. The gate insulating layer is disposed on the substrate, and covers the gate and the first transflective conductive layer. The channel layer is disposed on the gate insulating layer and located above the gate. The conductive layer includes a source and a data line connected to the source. The connection type of the thin film transistor and the data line is not limited there-to as such. In other words, in another embodiment, when the thin film transistor is a p-type thin film transistor, the drain is connected to the data line. The second transflective conductive layer contacts the channel layer, and extends from the surface of the channel layer to the surface of the gate insulating layer located above the first transflective conductive layer. The passivation layer is disposed on the conductive layer and on a portion of the second transflective conductive layer.

In an embodiment of the present invention, the material of the conductive layer includes silver, silver alloy, aluminum or molybdenum.

In an embodiment of the present invention, the first transflective conductive layer and the second transflective conductive layer form a storage capacitor.

The present invention further provides a LCD panel including a bottom substrate, a plurality of aforementioned transflective pixels disposed on the bottom substrate, a top substrate and a liquid crystal layer. The top substrate is disposed opposite to the bottom substrate, and the liquid crystal layer is disposed between the bottom substrate and the top substrate.

In a LCD panel of the present invention, arrangement of the transflective pixels includes a three pixels arrangement on the substrate. In other embodiments, the arrangement of the pixel unit may be a mosaic pixel arrangement, a stripe pixel arrangement, a delta pixel arrangement or a four pixels arrangement on the bottom substrate.

In the transflective pixel of the present invention, the structure that the gate insulating layer and the passivation layer or the combination thereof being disposed between the first transflective conductive layer and the second transflective conductive layer forms an optical filter. The wavelength of the light reflected by the optical filter can be adjusted based on interference of the lights reflected on different films when passing through the first transflective conductive layer and the second transflective conductive layer. Therefore, the transflective pixel may adjust the display colors without requiring color filter films, and accordingly, and a colorful display effect can be achieved by a display having the transflective pixels of the present invention. Meanwhile, the transflective pixel of the present invention may simultaneously have a reflective display mode and a transmissive display mode without applying a translucent reflector, and therefore the aperture ratio of the pixels is enhanced. It should be noted that fabrication of the optical filter can be integrated with fabrication of the thin film transistor according to the present invention, and therefore the interference occurred between the thin film transistor and the conductive layer of the optical filter can be reduced, such that the distortion during signal transmission of the thin film transistor can be avoided, and the display quality is improved. Moreover, the manufacturing process of the first transflective conductive layer and the second transflective conductive layer of the transflective pixel of the present invention is compatible to the current manufacturing process, and therefore the production cost is reduced and the manufacturing process of the LCD panel is simplified.

In order to make the aforementioned and other objects, features and advantages of the present invention comprehensible, a preferred embodiment accompanied with figures is described in detail below.

### BRIEF DESCRIPTION OF THE DRAWINGS

FIG. 1 is a schematic diagram of a conventional transflective LCD panel.

FIG. 2 is a schematic diagram of another conventional transflective LCD panel.

FIG. 3 is a diagram illustrating a transflective pixel according a first embodiment of the present invention.

FIG. 4 is a diagram illustrating a transflective pixel according a second embodiment of the present invention.

FIG. 5 is a diagram illustrating a transflective pixel according a third embodiment of the present invention.

FIG. 6 is a diagram illustrating a transflective pixel according a fourth, embodiment of the present invention.

FIG. 7 is a diagram illustrating a transflective pixel according a fifth embodiment of the present invention.

FIG. 8 is a schematic diagram of a LCD panel according to the present invention.

FIG. 9A is transmissive spectrums of a light respectively processed by the red/green/blue optical filters of the present invention.

FIG. 9B is reflective spectrums of a light respectively processed by the red/green/blue optical filters of the present invention.

FIG. 10 is a schematic diagram of a LCD 900 according to the present invention.

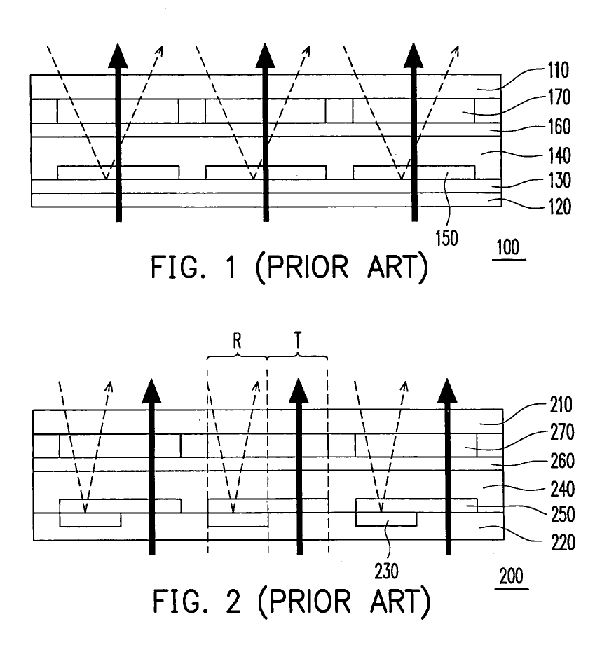

### DESCRIPTION OF EMBODIMENTS

### The First Embodiment

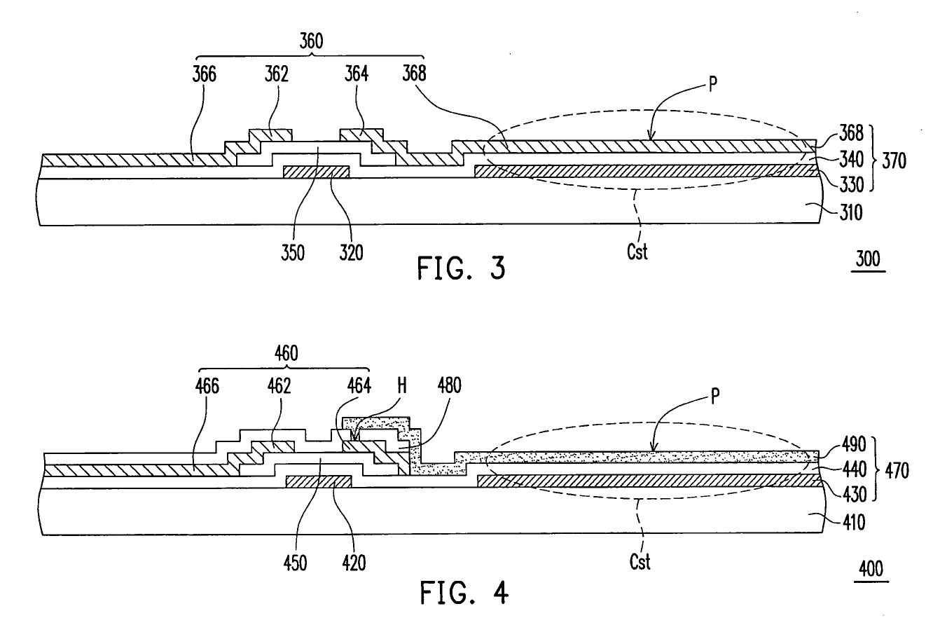

FIG. 3 is a diagram illustrating a transflective pixel 300 according a first embodiment of the present invention. Referring to FIG. 3, the transflective pixel 300 including a gate 320, a first transflective conductive layer 330, a gate insulating layer 340, a channel layer 350 and a conductive layer 360 is disposed on a substrate 310. The gate 320 and the first transflective conductive layer 330 are disposed on the substrate 310, wherein the first transflective conductive layer 330 is electrically isolated from the gate 320. The gate insulating layer 340 covers the gate 320 and the first transflective conductive layer 330. The channel layer 350 is disposed on the gate insulating layer 340 above the gate 320. The conductive layer 360 is disposed on the gate insulating layer 340 and on a portion of the channel layer 350. In the present embodiment, the material of the first transflective conductive layer 330 may be silver, silver alloy, aluminum or molybdenum and the material of the conductive layer 360 may be silver, silver alloy, aluminum or molybdenum. The conductive layer 360 includes a source 362, a drain 364, a data line 366 connected to the source 362 and a second transflective conductive layer 368 connected to the drain 364, wherein the second transflective conductive layer 368 is disposed on the gate insulating layer 340 above the first transflective conductive layer 330. It should be noted that in FIG. 3, the first transflective conductive layer 330 and the second transflective conductive layer 368 form a storage capacitor Cst for maintaining a stable display quality of the transflective pixel 300. Since the area of the first transflective conductive layer 330 and the second transflective conductive layer 368 is not directly related to the aperture ratio, the storage capacitance and the aperture ratio can be simultaneously optimized.

Moreover, it should be noted that the structure that the gate insulating layer 340 being disposed between the first transflective conductive layer 330 and the second transflective conductive layer 368 forms an optical filter 370. The material of the gate insulating layer 340 may be silicon oxide, silicon nitride, aluminum oxide, titanium oxide, magnesium fluoride, zirconium dioxide, niobium pentoxide or other dielectric materials. In particular, the wavelength of the light emitted from the transflective pixel 300 can be adjusted based on the interference of the light being reflected when passing through the first transflective conductive layer 330 and the second transflective conductive layer 368. Therefore, the transflective pixel 300 may achieve a colourful display effect without requiring the color filter films. In other words, the display color of the transflective pixel 300 can be adjusted by adjusting the thickness of the gate insulating layer 340, so as to achieve a colourful display effect of the displays having the transflective pixel 300 of the present invention.

In addition, the transflective pixel 300 may simultaneously have a reflective display mode and a transmissive display mode without applying a translucent reflector, and therefore the aperture ratio of the pixels is enhanced. Moreover, the manufacturing process of the optical filter 370 formed by the first transflective conductive layer 330, the second transflective conductive layer 368 and the gate insulating layer 340 therebetween is compatible to the current manufacturing process, and the second transflective conductive layer 368 may simultaneously function as a pixel electrode P. In other words, a coupling phenomenon between the first transflective conductive layer 330, the second transflective conductive layer 368 and other conductive films is significantly reduced and the unnecessary parasitic capacitance can be avoided, meanwhile, the manufacturing process is simplified, and therefore may not incur additional production cost.

### The Second Embodiment

FIG. 4 is a diagram illustrating a transflective pixel 400 according a second embodiment of the present invention. Referring to FIG. 4, the transflective pixel 400 including a gate 420, a first transflective conductive layer 430, a gate insulating layer 440, a channel layer 450, a conductive layer 460, a passivation layer 480 and a second transflective conductive layer 490 is disposed on a substrate 410. The gate 420 and the first transflective conductive layer 430 are disposed on the substrate 410, wherein the first transflective conductive layer 430 is electrically isolated from the gate 420. The gate insulating layer 440 is disposed on the substrate 410 and covers the gate 420. The channel layer 450 is disposed on the gate insulating layer 440 above the gate 420. The conductive layer 460 is disposed on a portion of the channel layer 450. In the present embodiment, the material of the first transflective conductive layer 430 may be silver, silver alloy, aluminum or molybdenum and the material of the conductive layer 460 may be silver, silver alloy, aluminum or molybdenum. The conductive layer 460 includes a source 462, a drain 464 and a data line 466. The passivation layer 480 is disposed on a portion of the conductive layer 460. The second transflective conductive layer 490 is disposed on a portion of the passivation layer 480 and located above the first transflective conductive layer 430. As shown in FIG. 4, the gate insulating layer 440 of the transflective pixel 400 covers the first transflective conductive layer 430, and the second transflective conductive layer 490 is disposed on the gate insulating layer 440.

To avoid problems caused by the floating of the second transflective conductive layer 490 over the first transflective conductive layer 430, the passivation layer 480 of the present embodiment has a contact window H exposing a portion of the drain 464, such that the second transflective conductive layer 490 may be electrically connected to the drain 464 through the contact window H. Moreover, as shown in FIG. 4, since the second transflective conductive layer 490 is electrically connected to the drain 464, the second transflective conductive layer 490 may function as a pixel electrode P used for applying voltages to the liquid crystal layer (not shown).

On the other hand, the first transflective conductive layer 430 and the second transflective conductive layer 490 may form a storage capacitor Cst used for maintaining the voltage of the pixel electrode P, so as to maintain a stable display quality of the transflective pixel 400.

In addition, it should be noted that in the present embodiment, the structure that the gate insulating layer 440 being disposed between the first transflective conductive layer 430 and the second transflective conductive layer 490 forms an optical filter 470. The material of the gate insulating layer 440 may be silicon oxide, silicon nitride, aluminum oxide, titanium oxide, magnesium fluoride, zirconium dioxide, niobium pentoxide or other dielectric materials. Similar to the first embodiment, the wavelength of the light emitted from the transflective pixel 400 can be adjusted by adjusting the thickness of the gate insulating layer 440, so as to adjust the display color of the transflective pixel 400, and achieve a colourful display effect of the displays having the transflective pixel 400 of the present invention.

In addition, the transflective pixel 400 may simultaneously have a reflective display mode and a transmissive display mode without applying a translucent reflector, and therefore the aperture ratio of the pixels is improved. Moreover, the manufacturing process of the first transflective conductive layer 430, the second transflective conductive layer 490 and the gate insulating layer 440 there between is compatible to the present existing manufacturing process, and therefore, similar to the first embodiment, and may not incur additional production cost. The rest of the detail description is omitted.

### The Third Embodiment

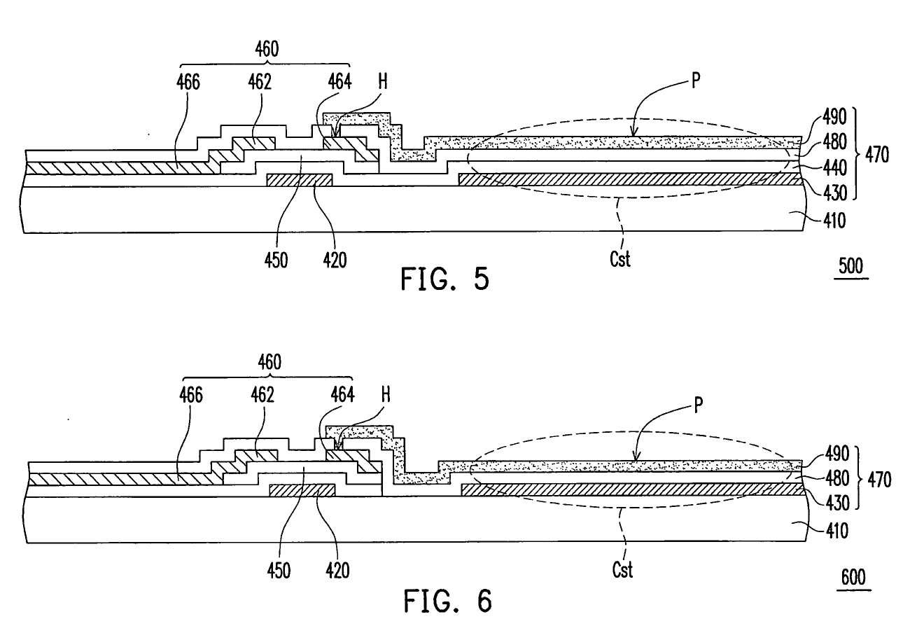

FIG. 5 is a diagram illustrating a transflective pixel 500 according a third embodiment of the present invention. Referring to FIG. 5, the transflective pixel 500 of the present embodiment is similar to that of the second embodiment, except for a portion of the gate insulating layer 440 of the transflective pixel 500 may cover the first transflective conductive layer 430, the passivation layer 480 may cover a portion of the gate insulating layer 440 located above the first transflective conductive layer 430, and the second transflective conductive layer 490 is disposed on the passivation layer 480. To avoid problems caused by floating of the second transflective conductive layer 490 over the first transflective conductive layer 430, the passivation layer 480 of the present embodiment has a contact window H exposing a portion of the drain 464, such that the second transflective conductive layer 490 may be electrically connected to the drain 464 through the contact window H, and the second transflective conductive layer 490 may also function as a pixel electrode P used for applying voltages to the liquid crystal layer (not shown).

As shown in FIG. 5, the optical filter 470 of the present embodiment is composed of the first transflective conductive layer 430, the second transflective conductive layer 490 and the gate insulating layer 440 and the passivation layer 480 there between. The material of the first transflective conductive layer 430 and the second transflective conductive layer 490 may be silver, silver alloy, aluminum or molybdenum. The material of the gate insulating layer 440 and the passivation layer 480 may be silicon oxide, silicon nitride, aluminum oxide, titanium oxide, magnesium fluoride, zirconium dioxide, niobium pentoxide or other dielectric materials. Similar to the second embodiment, the wavelength of the light emitted from the transflective pixel 500 can be adjusted by adjusting the thickness of the gate insulating layer 440 and the passivation layer 480, so as to adjust the display colors of the transflective pixel 500 and achieve a colourful display effect of the displays having the transflective pixel 500 of the present invention. Moreover, the transflective pixel 500 also has the advantages of enhanced aperture ratio and incurrence of not additional production cost, and the detail description is omitted.

### The Fourth Embodiment

FIG. 6 is a diagram illustrating a transflective pixel 600 according a fourth embodiment of the present invention. Referring to FIG. 6, the transflective pixel 600 of the present embodiment is similar to that of the second embodiment, except for the passivation layer 480 directly covering the first transflective conductive layer 430, and the second transflective conductive layer 490 being disposed on the passivation layer 480, wherein the passivation layer 480 has a contact window H exposing part of the drain 464, such that the second transflective conductive layer 490 may be electrically connected to the drain 464 through the contact window H, and the second transflective conductive layer 490 may also function as a pixel electrode P used for applying voltages to the liquid crystal layer (not shown).

As shown in FIG. 6, the optical filter 470 of the present embodiment is composed of the first transflective conductive layer 430, the second transflective conductive layer 490 and the passivation layer 480 there between. The material of the first transflective conductive layer 430 and the second transflective conductive layer 490 may be silver, silver alloy, aluminum or molybdenum. The material of the passivation layer 480 may be silicon oxide, silicon nitride, aluminum oxide, titanium oxide, magnesium fluoride, zirconium dioxide, niobium pentoxide or other dielectric materials. Similar to the second embodiment, the wavelength of the light emitted from the transflective pixel 600 can be adjusted by adjusting the thickness of the passivation layer 480, so as to adjust the display color of the transflective pixel 600 and achieve a colourful display effect of the displays having the transflective pixel 600 of the present invention. Moreover, the transflective pixel 600 also has the advantages of improved aperture ratio and incurrence of no additional production cost, and the detail description thereof is omitted.

### The Fifth Embodiment

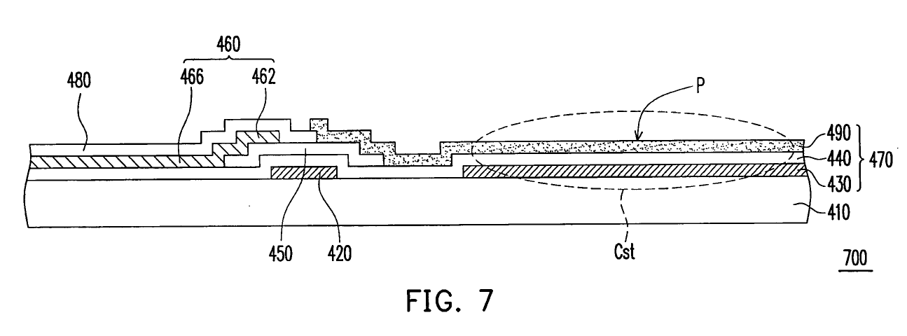

FIG. 7 is a diagram illustrating a transflective pixel 700 according a fifth embodiment of the present invention. Referring to FIG. 7, the transflective pixel 700 of the present embodiment is similar to that of the fourth embodiment, except for the second transflective conductive layer 490 extends from the surface of the channel layer 450 to the surface of the gate insulating layer 440 disposed above the first transflective conductive layer 430. In other words, during the fabrication of the second transflective conductive layer 490, the drain 464 as described in the fourth embodiment can be fabricated simultaneously. Therefore, the second transflective conductive layer 490 located above the gate 420 may function as a drain of the component switch, and the second transflective conductive layer 490 located above the first transflective conductive layer 430 may function as the optical filter 470. Moreover, the second transflective conductive layer 490 may also function as a pixel electrode P used for applying voltages to the liquid crystal layer (not shown). In addition, the passivation layer 480 is disposed on the conductive layer 460. In another embodiment, the passivation layer 480 may be fabricated after the second transflective conductive layer being fabricated, such that the passivation layer 480 may be disposed on the conductive layer 460 and on a portion of the second transflective conductive layer 490.

As shown in FIG. 7, the optical filter 470 of the present embodiment is composed of the first transflective conductive layer 430, the second transflective conductive layer 490 and the gate insulating layer 440 there between. The material of the first transflective conductive layer 430 and the second transflective conductive layer 490 may be silver, silver alloy, aluminum or molybdenum. The material of the gate insulating layer 440 may be silicon oxide, silicon nitride, aluminum oxide, titanium oxide, magnesium fluoride, zirconium dioxide, niobium pentoxide or other dielectric materials. Similar to the fourth embodiment, the wavelength of the light emitted from the transflective pixel 700 can be adjusted by adjusting the thickness of the gate insulating layer 440, so as to adjust the display colors of the transflective pixel 700 and achieve a colourful display effect of the displays using the transflective pixel 700 of the present invention. Moreover, the transflective pixel 700 also has the advantages of enhanced aperture ratio and incurrence of no additional production cost, and the detail description thereof is omitted.

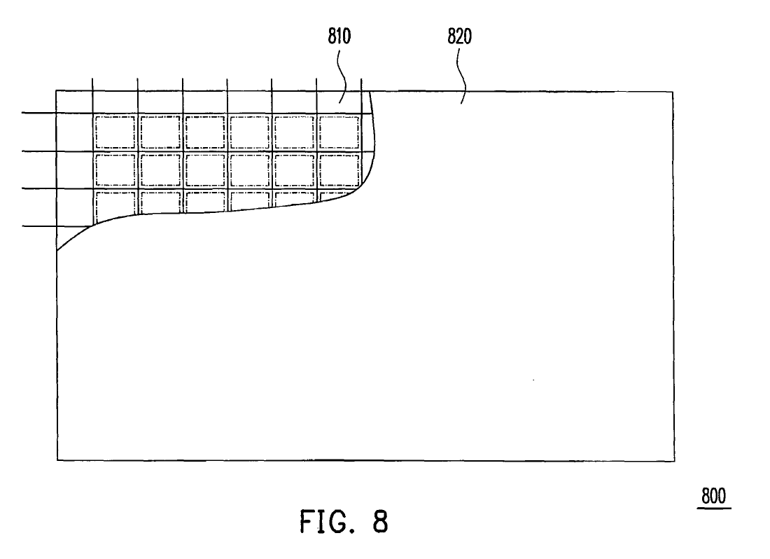

FIG. 8 is a schematic diagram of another LCD panel according to the present invention. The LCD panel 800 includes a bottom substrate 810, a plurality of aforementioned pixels (300, 400, 500, 600, 700 or the combination thereof) disposed on the bottom substrate 810, a top substrate 820 and a liquid crystal layer (not shown). The top substrate 820 is disposed opposite to the bottom substrate 810, and the liquid crystal layer (not shown) is disposed between the bottom substrate 810 and the top substrate 820. Furthermore, the plurality of aforementioned pixels (300, 400, 500, 600, 700 or the combination thereof) may be arranged in different arrays on the bottom substrate 810. Arrangement of the aforementioned pixels (300, 400, 500, 600, 700 or the combination thereof) in arrays on the substrate includes a stripe pixel arrangement, a mosaic pixel arrangement, a delta pixel arrangement and a four pixels arrangement etc.

TABLE 1

| | | Thickness |
|---|---|---|
| Film structure | Material | (nm) |
| The first and second | Silver | 5~60 |
| transflective conductive layer | | |
| Gate insulating layer (R) | Silicon dioxide | 150-200 |
| Gate insulating layer (G) | Silicon dioxide | 110-160 |
| Gate insulating layer (B) | Silicon dioxide | 70-110 |

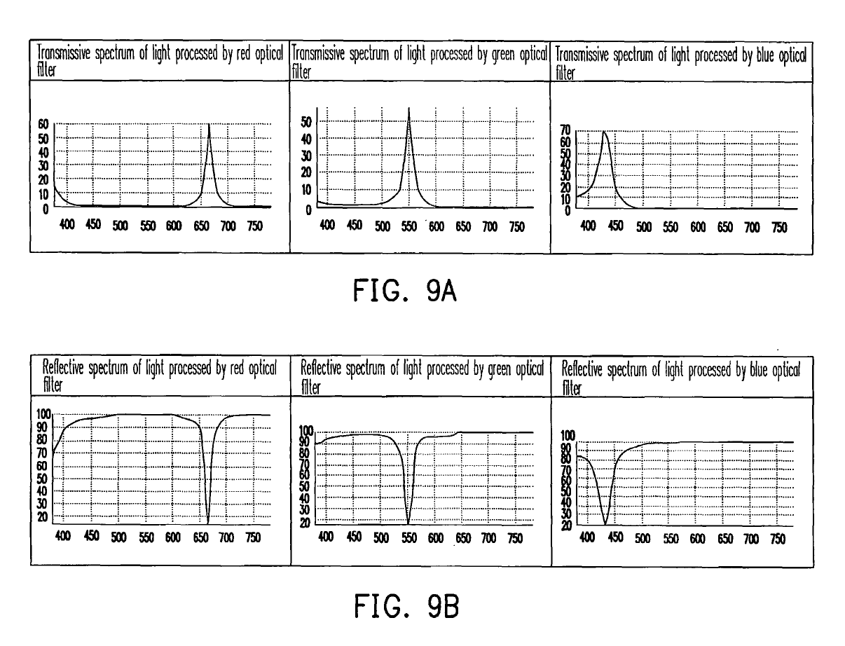

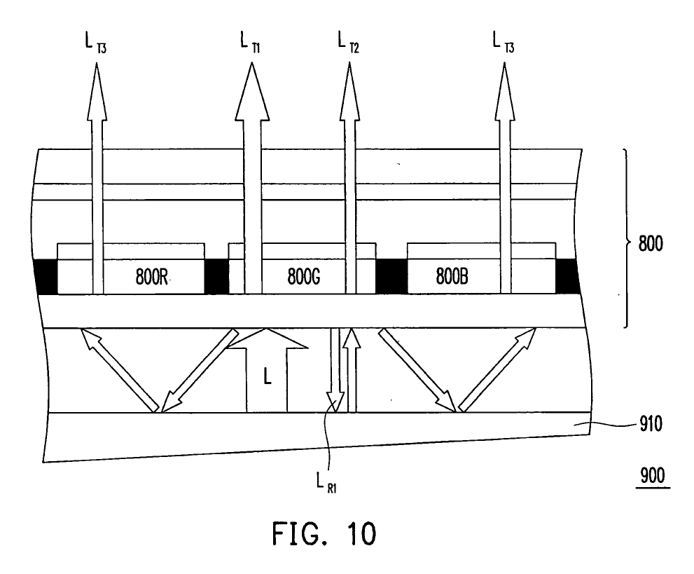

The pixel structure of the first embodiment (i.e. the pixel structure of FIG. 3) is taken as an example for describing the transmissive feature and the reflective feature of the optical filter. FIG. 9A shows transmissive spectrums of a light respectively passing through the pixels having red (R)/green (G)/blue (B) optical filters, FIG. 9B shows reflective spectrums of a light respectively passing through the pixels having red (R)/green (G)/blue (B) optical filters. Referring to table 1 and FIG. 9A, table 1 discloses the material and thickness of each film of the optical filter. In the visible lights, the wavelength of the red light is about 650 nanometers, the wavelength of the green light is about 546.1 nanometers, and the wavelength of the blue light is about 450 nanometers. Here, a light source of white light is applied to irradiate the optical filters, and the transmittances of the lights having different wavelengths are measured after the lights being processed by the optical filters. If the thickness of the gate insulating layer (R) is between 150-200 nanometers, the visible light having a wavelength between 650-670 nanometers has a highest transmittance, and the visible light close to a red light will be viewed, and therefore the optical filter has a red display effect. If the thickness of the gate insulating layer (G) is between 110-160 nanometers, the visible light having a wavelength around 550 nanometers has a highest transmittance, and the visible light close to a green light will be viewed, and therefore the optical filter has a green display effect. When the thickness of the gate insulating layer (B) is between 70-110 nanometers, the visible light having a wavelength between 420-440 nanometers has a highest transmittance, and the visible light close to a blue light will be viewed, and therefore the optical filter has a blue display effect. Since the transmissive spectrum of the optical filter has a narrow bandwidth, the optical filter has a relatively high color purity and a good display effect.

Referring to table 1 and FIG. 9B, the optical filter having a thickness of its gate insulating layer (R) between 150-200 nanometers allows the visible light with a wavelength between 650-670 nanometers (close to red light) passing through, and therefore the light reflected by the optical filter becomes a mixed light (e.g. cyan light) of the green light and the blue light. Similarly, the optical filter having a thickness of its gate insulating layer (G) between 110-160 nanometers allows the visible light with a wavelength around 550 nanometers (close to green light) passing through, and therefore the light reflected by the optical filter becomes a mixed light (e.g. magenta light) of the red light and the blue light. The optical filter having a thickness of its gate insulating layer (B) between 70-110 nanometers allows the visible light with a wavelength between 420-440 nanometers (close to blue light) passing through, and therefore the light reflected by the optical filter becomes a mixed light (e.g. yellow light) of the red light and the green light. Supposing the light beam enters the pixel array having red, green and blue optical filters from one side, lights with corresponding colors of the optical filters will be shown on the other side of the pixel array, and on the light incident side, the single-color light closed to white light will be shown due to re-mixing of the aforementioned mixed lights.

Therefore, the aforementioned LCD panel 800 may be applied to the transmissive mode and the reflective mode, and the color performance relates to the transmissive mode and the reflective mode. For example, the optical filters of the aforementioned pixels, having red/green/blue colors are arranged in an array on the bottom substrate 810. When the LCD panel 800 is in a transmissive mode (i.e. using a light source of backlight module), the light beam provided by the backlight module passes through the optical filters of the pixel array disposed on the bottom substrate 810, and passes through the liquid crystal layer (not shown), and therefore the LCD panel 800 may control the display colors and achieve a colourful display effect. Since the optical filter has a narrow bandwidth, its color purity is relatively high. When the LCD panel is in a reflective mode, the external light beam first passes through the liquid crystal layer (not shown) and then is reflected by the optical filters of the pixel array disposed on the bottom substrate 810, and forms a reflective light corresponding to the reflective spectrum and then emits out through the liquid crystal layer (not shown). Therefore, the light viewed by a spectator is formed by an external light being reflected by the optical filters of the pixel array disposed on the bottom substrate 810, and processed by the liquid crystal layer. FIG. 10 is a schematic diagram of a LCD 900 according to the present invention. Referring to FIG. 10, the LCD 900 includes the aforementioned LCD panel 800 and a backlight module 910, and only three pixels 800R/800G/800B having red/green/blue colors are illustrated, for an example, wherein the optical filters having red/green/blue transmissive spectrum features are respectively set to the three pixels. As shown in FIG. 10, light L provided by the backlight module passes through the pixel 800G having a green optical filter, and forms a green transmissive light L_{T1} and a reflected light L_{R1} returned back to the backlight module 910. Then, a part of the reflected light L_{R1} is reflected by the backlight module 910 and emits out directly through the pixel 800G to form a green transmissive light L_{T2}, meanwhile, the other part of the reflected light L_{R1} is reflected several times on the backlight module 910 and emits out through the adjacent pixels 800R and 800B to respectively form a red transmissive light L_{T3} and a blue transmissive light L_{T3}. Similarly, light utilization of the pixels 800R/800B having red/blue optical filters is the same, and detail description thereof is omitted. Therefore, the light utilization of the backlight module can be improved according to the present invention.

In summary, in a transflective pixel of the present invention, the structure that a gate insulating layer and a passivation layer or a combination thereof being disposed between a first transflective conductive layer and a second transflective conductive layer forms an optical filter. Therefore, the transflective pixel may achieve a colourful display effect such as red, blue, green etc. without requiring the color filter films, and since the light absorption of the color filter films is avoided, utilization of the light source is improved. Moreover, the transflective pixel of the present invention may simultaneously have a reflective display mode and a transmissive display mode without applying a translucent reflector, and therefore the aperture ratio of the pixels is improved. It should be noted that fabrication of the optical filter and the thin filh transistor is integrated according to the present invention, which is different from the conventional partially overlapped design between the optical filter and the thin film transistor, and therefore the interference occurred between the thin film transistor and the conductive layer of the optical filter can be reduced, such that the distortion during signal transmission of the thin film transistor can be avoided, and the display quality is improved. Moreover, the manufacturing process of the films in the transflective pixel of the present invention is compatible to the current manufacturing process, and therefore the production cost may be reduced and the manufacturing process of the LCD panel may be simplified.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A transflective pixel disposed on a substrate, comprising:
a gate disposed on the substrate;
a first transflective conductive layer disposed on the substrate and electrically insulated from the gate;
a gate insulating layer disposed on the substrate, wherein the gate and the first transflective conductive layer are covered by the gate insulating layer;
a channel layer disposed on the gate insulating layer and located above the gate; and
a conductive layer disposed on the gate insulating layer and on a portion of the channel layer, wherein the conductive layer comprises a source, a drain, a data line connected to the source and a second transflective conductive layer connected to the drain, and the second transflective conductive layer is disposed on the gate insulating layer above the first transflective conductive layer.

2. The transflective pixel as claimed in claim 1, wherein the conductive layer comprises silver, silver alloy, aluminum or molybdenum.

3. The transflective pixel as claimed in claim 1, wherein the first transflective conductive layer and the second transflective conductive layer form a storage capacitor.

4. A transflective pixel disposed on a substrate, comprising:
a gate disposed on the substrate;
a first transflective conductive layer disposed on the substrate and electrically insulated from the gate;
a gate insulating layer disposed on the substrate, wherein the gate is cover by the gate insulating layer;
a channel layer disposed on the gate insulating layer and located above the gate;
a conductive layer disposed on a portion of the channel layer, wherein the conductive layer comprises a source, a drain and a data line;
a passivation layer disposed on a portion of the conductive layer; and
a second transflective conductive layer disposed on a portion of the passivation layer, wherein the second transflective conductive layer is electrically connected to the drain and located above the first transflective conductive layer.

5. The transflective pixel as claimed in claim 4, wherein the gate insulating layer covers the first transflective conductive layer, and the second transflective conductive layer is disposed on the gate insulating layer.

6. The transflective pixel as claimed in claim 5, wherein the passivation layer has a contact window exposing part of the drain, and the second transflective conductive layer is electrically connected to the drain through the contact window.

7. The transflective pixel as claimed in claim 4, wherein the gate insulating layer covers the first transflective conductive layer, the passivation layer covers the insulation layer above the first transflective conductive layer, and the second transflective conductive layer is disposed on the passivation layer.

8. The transflective pixel as claimed in claim 7, wherein the passivation layer has a contact window exposing part of the drain, and the second transflective conductive layer is electrically connected to the drain through the contact window.

9. The transflective pixel as claimed in claim 4, wherein the passivation layer covers the first transflective conductive layer, and the second transflective conductive layer is disposed on the passivation layer.

10. The transflective pixel as claimed in claim 9, wherein the passivation layer has a contact window exposing part of the drain, and the second transflective conductive layer is electrically connected to the drain through the contact window.

11. The transflective pixel as claimed in claim 4, wherein the first transflective conductive layer and the second transflective conductive layer form a storage capacitor.

12. The transflective pixel as claimed in claim 4, wherein the conductive layer comprises silver, silver alloy, aluminum or molybdenum.

13. A transflective pixel, disposed on a substrate, comprising:
a gate disposed on the substrate;
a first transflective conductive layer disposed on the substrate, and electrically insulated from the gate;
a gate insulating layer disposed on the substrate, wherein the gate and the first transflective conductive layer are covered by the gate insulating layer;
a channel layer disposed on the gate insulating layer and located above the gate;
a conductive layer disposed on the gate insulating layer and on part of the channel layer, wherein the conductive layer comprises a source and a data line connected to the source;
a second transflective conductive layer contacted with the channel layer, wherein the second transflective conductive layer extends from a surface of the channel layer to a surface of the gate insulating layer above the first transflective conductive layer; and
a passivation layer disposed on the conductive layer.

14. The transflective pixel as claimed in claim 13, wherein the conductive layer comprises silver, silver alloy, aluminum or molybdenum.

15. The transflective pixel as claimed in claim 13, wherein the first transflective conductive layer and the second transflective conductive layer form a storage capacitor.

16. A liquid crystal display panel, comprising:
a bottom substrate;
a plurality of pixels as claimed in claim 1, claim 4 or claim 13, wherein the pixels are disposed on the bottom substrate;
a top substrate disposed opposite to the bottom substrate; and
a liquid crystal layer disposed between the bottom substrate and the top substrate.

17. The liquid crystal display panel as claimed in claim 16, wherein the pixels on the bottom substrate are arranged in a four pixels arrangement.

18. The liquid crystal display panel as claimed in claim 16, wherein the pixels on the substrate are arranged in a mosaic pixel arrangement.

19. The liquid crystal display panel as claimed in claim 16, wherein the pixels on the substrate are arranged in a stripe pixel arrangement.

20. The liquid crystal display panel as claimed in claim 16, wherein the pixels on the substrate are arranged in a delta pixel arrangement.
